(19) United States
(12) Patent Application Publication
(10) Pub. No.: US 2002/0067129 A1
(43) Pub. Date: Jun. 6, 2002

(54) FERRITE CORE FOR ELECTRODELESS FLOURESCENT LAMP OPERATING AT 50-500 KHZ

(76) Inventors: JOHN C. CHAMBERLAIN, SOMERVILLE, MA (US); OLEG POPOV, NEEDHAM, MA (US); EDWARD SHAPIRO, LEXINGTON, MA (US); ROBERT CHANDLER, LEXINGTON, MA (US); TOSHIAKI KURACHI, WOBURN, MA (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 09/303,951

(22) Filed: May 3, 1999

(51) Int. Cl. H01J 65/00

(52) U.S. Cl. 313/607

(57) ABSTRACT

An electrodeless fluorescent lamp operating at relatively low frequencies (50-500 kHz) whereby a ferrite core is utilized to generate the necessary magnetic and electric fields to maintain the discharge where the core material is Mn—Zn type combination due to its low power losses, 400 mW/cm₃, in the frequency range of 50-100 kHz and magnetic field strengths of 150 mT. Furthermore, the material may cover a variety of atomic percentages of Mn and Zn added to Fe₂O₃ base to obtain favorable grain boundary and crystalline structure, resulting in a practical ferrite core material, having a Curie temperature greater than 200° C. Such material enables the operation of electrodeless fluorescent lamps with powers ranging from 10 W to about 250 W at low frequencies, as mentioned above, in such a manner that ferrite core losses constitute less than 20% of the lamp power and heat generated by core losses is minimized.

### BACKGROUND

Electrodeless fluorescent lamps have been recently introduced in various markets around the world. From a consumer point of view, the major advantage of an electrodeless fluorescent lamp is the removal of the electrodes which are a life-limiting factor. Therefore, when a fluorescent lamp does not have electrodes, the life can be extended substantially compared to one with electrodes. This has been demonstrated in a variety of configurations and a variety of powers. For example, lamps on the market are operated at a frequency of 2.65 MHz and 13.56 MHz. Their rated powers range from about 25 W to 150 W and their lives range from 15,000 to about 60,000 hours. These lamps have been shown to have very good maintenance and good efficacy. However, one of the drawbacks of such lamps is their cost. Because of the complexities involved in the design of the circuitry to generate a voltage at a radio frequency (RF) band, the driver tends to be expensive. An additional reason for high cost is the need to prevent electromagnetic interference (EMI). Since there are federal regulations regarding EMI, one has to be extremely careful that there is no interference with communication systems, heart pacers or a variety of medical instrumentation. Therefore, while technologically demonstrated that practical and very long life fluorescent lamps are possible, the initial acquisition cost of such lamps have been a major impediment to widespread market penetration.

One of the important advances that can be made toward reducing the cost of the overall system is to reduce the operational frequency. If the frequency of operation is reduced from the typical 13.56 MHz or 2.65 MHz (which are the allowed frequencies in many countries) to a low kHz range (herein low frequency means 50-500 kHz) the complexity of the circuit is reduced dramatically. One could use components which are widely used in high volume production of electronic ballasts thus reducing the overall cost of the circuits. That, of course, has the potential of a wider penetration of electrodeless fluorescent lamp in the marketplace. In order to achieve such low frequencies and still generate the necessary magnetic and electric fields to maintain the discharge, one typically needs to use a ferrite material. The ferrite material of course is an important consideration in the low frequency operation.

Electrodeless lamps can be operated at frequencies around 50-500 kHz. The low frequency limit is determined by high coil currents needed to generate a high magnetic field which ignites and then maintains a discharge in a lamp. Indeed, the induced voltage in a lamp is:

V_{ind}=Vₚₗ=πRₚₗ²ωBₚₗ (1)

where ω=2πf is the angular driving frequency, Rₚₗ is the plasma radius and Bₚₗ is the magnetic field generated in the plasma by the coil current, I_{coil}:

Bₚₗ≅μₒμ_{eff}I_{coil}(N/H_{coil}) (2)

Here μ_{eff} is the effective medium permeability that is typically smaller than the permeability of the ferrite core, μ, used at such low frequencies. N is number of coil turns and H_{coil} is the coil height. For each particular gas and mercury vapor pressure and for each lamp geometry there is a particular value of V_{ind} needed for the ignition of the inductive discharge in a lamp. Therefore, as can be seen from Eq. 1, the decrease of the driving frequency, f, requires the increase of the magnetic field, Bₚₗ. The ferrite permeability, μ, does not vary with the frequency, f. N and H_{coil} are fixed values.

Therefore, the increase of Bₚₗ can be achieved only by the increase of the coil current, i.e., Bₚₗ α I_{coil}. So, at the fixed gas pressure and fixed lamp geometry, the decrease of the driving frequency, f, requires the increase of the magnetic field and, hence, the coil current, I_{coil}. Unfortunately, the increase of the coil current is not desirable because it causes an increase of the coil and ferrite losses:

Pₗₒₛₛ=I_{coil}R_{coil}+P_{ferr} (3)

Here R_{coil} is the coil resistance. P_{ferr} is power loss in the ferrite core. The increase of power losses reduces the lamp power efficiency and hence lamp efficacy.

As mentioned above, there are several advantages of using frequencies of 50-500 kHz rather than a frequency of 13.56 MHz and even frequency of 2.65 MHz which are allowed frequencies in many countries. The first advantage is the cost of the components of the driver that generally decreases as frequency decreases. The use of frequencies below 200 kHz makes the whole system several times less expensive than one designed to be operated at 13.56 MHz. The second advantage is associated with the possibility of locating the matching network distantly from the bulb (20-50 cm or more).

Finally, the efficiency of the driver operated at frequencies of 50-500 kHz is higher (˜90%) than that operated at 13.56 MHz (80%) and at 2.65 MHz (85%). As a result, the total system efficiency is expected to be about the same (or might even be even higher) as that at 13.56 MHz and at 2.65 MHz even if the lamp efficacy is slightly lower (a few percent) due to higher coil losses (higher coil current) and losses in ferrite.

### PRIOR ART

When the prior art is studied from the viewpoint of core materials, we note that van der Zaag (European Patent Application 0625794A1) as well as Postma et al (U.S. Pat. No. 4,536,675) have concentrated on the use and choice of optimum ferrite materials for operation at around 3 MHz. Since the design of the lamp they developed was centered at 2.65 MHz, the best ferrite materials having less than 150 mW/cm³ of power losses at that frequency and at about 10 mT magnetic field have turned out to be the Ni—Zn type and that has worked out better than Mn—Zn type of materials. This is because at a frequency of 3 MHz and a magnetic field of 10 mT, Mn—Zn materials have power losses of about 500-700 mW/cm³. Therefore it would appear that Ni—Zn ferrite with less than 150 mW/cm³ losses at 3 MHz would be the best choice. However, since the primary focus of

Pₗₒₛₛ=I²_{coil}R_{coil}+P_{ferr} (3)

Here R_{coil} is the coil resistance. P_{ferr} is power loss in the ferrite core. The increase of power losses reduces the lamp power efficiency and hence lamp efficacy.

As mentioned above, there are several advantages of using frequencies of 50-500 kHz rather than a frequency of 13.56 MHz and even frequency of 2.65 MHz which are allowed frequencies in many countries. The first advantage is the cost of the components of the driver that generally decreases as frequency decreases. The use of frequencies below 200 kHz makes the whole system several times less expensive than one designed to be operated at 13.56 MHz. The second advantage is associated with the possibility of locating the matching network distantly from the bulb (20-50 cm or more).

Finally, the efficiency of the driver operated at frequencies of 50-500 kHz is higher (˜90%) than that operated at 13.56 MHz (80%) and at 2.65 MHz (85%). As a result, the total system efficiency is expected to be about the same (or might even be even higher) as that at 13.56 MHz and at 2.65 MHz even if the lamp efficacy is slightly lower (a few percent) due to higher coil losses (higher coil current) and losses in ferrite.

### PRIOR ART

When the prior art is studied from the viewpoint of core materials, we note that van der Zaag (European Patent Application 0625794A1) as well as Postma et al (U.S. Pat. No. 4,536,675) have concentrated on the use and choice of optimum ferrite materials for operation at around 3 MHz. Since the design of the lamp they developed was centered at 2.65 MHz, the best ferrite materials having less than 150 mW/cm³ of power losses at that frequency and at about 10 mT magnetic field have turned out to be the Ni—Zn type and that has worked out better than Mn—Zn type of materials. This is because at a frequency of 3 MHz and a magnetic field of 10 mT, Mn—Zn materials have power losses of about 500-700 mW/cm³. Therefore it would appear that Ni—Zn ferrite with less than 150 mW/cm³ losses at 3 MHz would be the best choice. However, since the primary focus of the present invention is low frequency operation (50-500 kHz) we have found that the Ni—Zn ferrite is not the best material to use. The power losses in Ni—Zn ferrite were found to be higher than those in Mn—Zn ferrite in this frequency range. We found that with an Mn—Zn type material, the typical losses at 100 kHz, for example, are typically less than 1 mW/cm³ for the magnetic field of ≅10 mT and less than about 400 mW/cm₃ for the magnetic field of ≅150 mT which is substantially lower than the losses encountered in Ni—Zn ferrite at the same frequency and magnetic field (see FIG. 2). This has very important implications in heat management and lamp efficacy. The reason is that the power losses in the ferrite core affect the system adversely in two ways. One is that these losses, excess heat, has to be removed or channeled from the lamp driver circuitry (which is disposed in close proximity to the ferrite core in integral systems) to prevent damaging the FETs and other circuit components. This results in additional cost and complexity of the package. The second way is that the power efficiency of the system is reduced. The higher the losses in the ferrite core, the lower the power efficiency and the lower the efficacy of the system. Therefore, it becomes clear that for an efficient and low cost electrodeless lamp system, it is critically important to utilize the lowest loss core material.

### SUMMARY OF THE INVENTION

The present invention involves an electrodeless flourescent lamp including a glass envelope containing a fill of mercury and an inert gas. A ferrite core is disposed adjacent to the envelope. The core comprises a mixture of iron, manganese and zinc, the weight ratio of the manganese and zinc to the iron being between about 0.2 and 0.7, the weight ratio of the zinc to the manganese being between about 0.2 to 2.0.

An objective of this invention is to provide a lower power loss ferrite core material in conjunction with the low frequency operation of an electrodeless fluorescent lamp.

Another objective of this invention to provide the highest lamp efficacy by minimizing the losses in a variety of components one of which is the ferrite core material and to define a core material having very small power losses at frequencies of operation of 50-500 kHz in an electrodeless fluorescent lamp.

A further objective of this invention to provide a core material which has a Curie temperature greater than 200° C. and therefore does not deteriorate under normal operational conditions as well as operational conditions in hot fixtures having an ambient temperature of 40-50° C.

Another objective of the present invention to provide a magnetic core material suitable for operation of electrodeless fluorescent lamps at low frequencies (50-500 kHz) that have low ignition power and a low ignition voltage that is manageable (<2000V) from safety and cost points of view.

A feature of the present invention is the use of a ferrite core having a composition of Mn and Zn between about 10% and 25% by weight of Mn, and between about 5% and 20% by weight of Zn, and 65-75% by weight of iron.

### BRIEF DESCRIPTION OF THE DRAWINGS

Reference is made to the accompanying drawing in which there are shown illustrative embodiments of the invention from which its novel features and advantages will be apparent, wherein:

FIG. 1 is an elevational view, partially in cross section, showing a typical configuration of an electrodeless fluorescent lamp capable of operating at low frequencies with core material described in the present invention.

FIG. 2 shows curves illustrating the measured power losses in the Mn—Zn ferrite employed in the present invention and losses in Ni—Zn type of material employed in the prior art as a function of frequency for two different magnetic field strengths.

FIG. 3 is a curve showing the Q-factor of the coil that employs a ferrite core made from Mn—Zn material. The Q-factor was measured at frequencies from 50 kHz to 350 kHz. Q factor is a measure of an inductor's “lossnesses”, Q=ω L/R where L is the inductance of the coil with the ferrite and R is the effective resistance of the coil with the ferrite.

FIG. 4 are curves illustrating the starting power, Pₛₜ, and starting current, Iₛₜ for the lamp operated at 23 W as a function of the driving frequency. The core was made from Mn—Zn ferrite.

FIG. 5 are curves illustrating ferrite power losses and lamp efficacy as a function of the driving frequency. The lamp power was 23 W. The ferrite core was made from Mn—Zn ferrite, model MN 80.

FIG. 6 presents curves showing the lamp light output and efficacy as a function of frequency; P=23 W, diameter of the bulb, D_{b}=60 mm; heighth of the bulb, H_{b}=65 mm.

### DESCRIPTION OF THE PREFERRED EMBODIMENTS

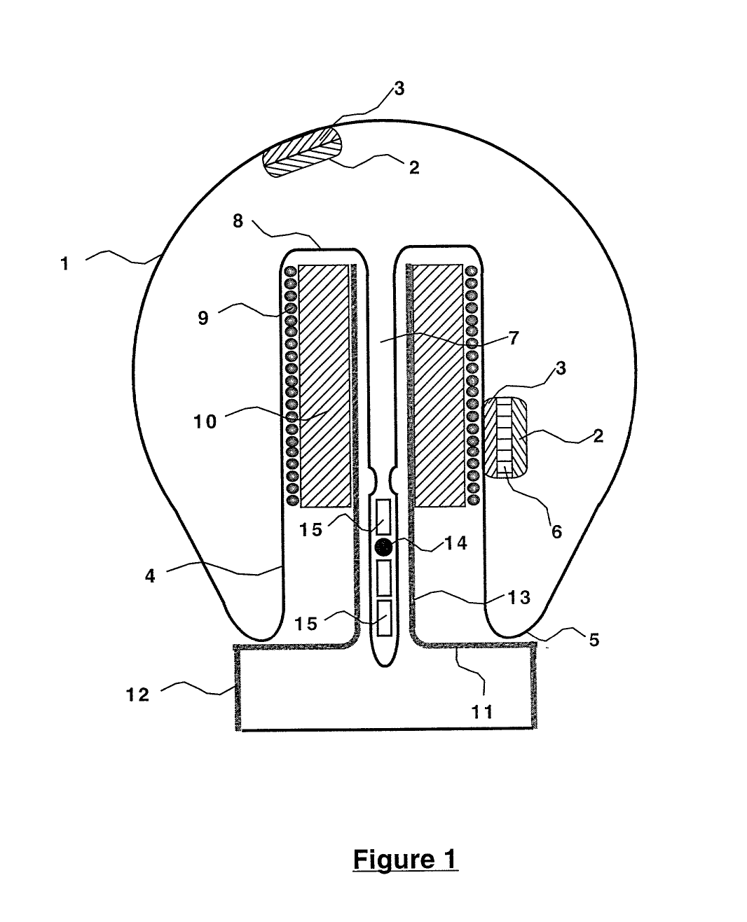

Referring to FIG. 1, a bulbous envelope 1 is shown with a coating 2 of a conventional phosphor. A protective coating 3 formed of silica or alumina, or the like, is disposed between the envelope 1 and the phosphor coating 2. The envelope 1 has a reentrant cavity 4 disposed in the bottom 5. The inner walls of the reentrant cavity 4 also have the phosphor coating 2, reflective coating 6, and the protective coating 3. The exhaust tubulation 7 can be disposed on the envelope axis or off the envelope axis.

In the preferred embodiment, the exhaust tubulation 7 is disposed on the envelope axis and connected to the envelope at the upper part 8 of the inner cavity 4. The envelope 1 contains a mixture of inert gas such as argon or krypton, or the like and a vaporizable metal, such as mercury, sodium and/or cadmium.

A coil 9 is made from Litz wire (see U.S. patent application 09/083,820 by Popov et al and owned by the same asignee as the present application) and is wound around a ferrite hollow core 10 made from Mn—Zn material having high permeability (>4000). The ferrite core 10 has a high Curie temperature (Tc>200° C.) and low power losses at frequencies of 50-1000 kHz. In the preferred embodiment, a ferrite core that was 55 mm high, 14 mm outer diameter, and 7 mm inner diameter, was employed. At a driving frequency of 100 kHz, and with the magnetic field at the ferrite core of about 830 G, needed to maintain plasma at f=100 kHz, the power losses were less than 100 mW/cm³ at ferrite temperatures from −10° C. to +150° C.

The induction coil 9 has from 10 to 80 turns depending on the length of the cavity 4 and the ferrite core 10. The coil 9 has pitches between the turns, and each pitch has a height from slightly greater than 0 to 10 mm. The combined inductance of the coil/ferrite core assembly has a value from 10 to 500 μH depending on the ferrite core length and number of turns. The bottom 5 of the envelope 1 is disposed on the top surface 11 of a lamp base 12.

Leads extend from the induction coil 9 and connect the coil 9 to a matching network (not shown) located inside of the lamp base 12. One of the leads is connected to the high HF voltage terminal of the matching network and the other lead is HF grounded. A high frequency driver provides the matching network with the voltage and current of the required frequency, that can be from 50 to 500 kHz.

A metal (aluminum, copper) cylinder 13 is inserted between the ferrite core 10 and the tubulation 7 and is connected to the top surface 11. The cylinder 13 redirects heat from the ferrite core and cavity to the base 12 as is explained in the Popov et al application (Ser. No. 09/083,820). An amalgam 14 is located inside the tubulation 7. It provides metal vapor (mercury, sodium, cadmium, or the like) in the envelope and controls metal vapor pressure therein. A few pieces of glass rods 15 are placed in the tubulation 7 to keep the amalgam 14 in the chosen place.

We carried out a study of electrodeless fluorescent lamps with reentrant cavity (shown in FIG. 1) and operated at frequencies from 80 to 500 kHz. Fill pressure (Ar, Kr) was between 0.1 and 2.0 torr. The mercury pressure was controlled by the amalgam located in the central tubulation. To operate at low frequencies of 50-500 kHz, various models of Mn—Zn ferrite were tried. The typical experimental setup consisted of a signal generator, an amplifier, a directional coupler connected to a forward and reflected power meter, current/voltage phase shift meter, matching network, oscilloscope, and a Rogowski loop for coil current measurements.

In a typical electrodeless fluorescent lamp filled with a mixture of inert gases (Ar, Kr, 0.1-2 torr) and mercury vapor, the discharge appears at first as a capacitive discharge. Indeed, the breakdown electric field of the capacitive discharge at all frequencies used (from 80 kHz to 500 kHz) was found to be lower than that of the inductive discharge. Further increases of the coil voltage causes the ignition of an inductive discharge which is accompanied by a drop in the coil voltage and current and the appearance of a bright plasma in the lamp volume.

We measured power losses in the ferrite core/coil at lamp ignition (Pₛₜ) and during operation (Pₗₒₛₛ) the coil ignition voltages (Vₛₜ) and currents (Iₛₜ). We also measured coil current and voltage during operation, Iₘ and Vₘ.

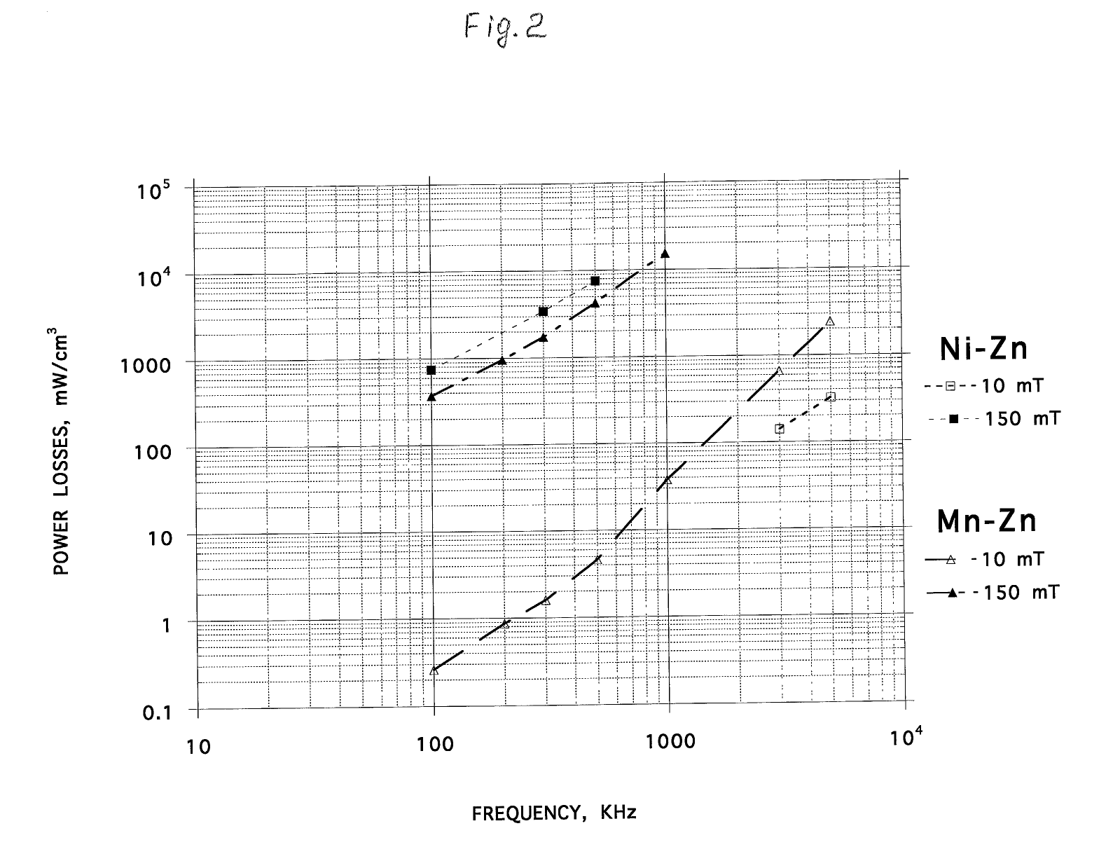

In FIG. 2 we show the measured power losses per unit volume as a function of frequency for two types of ferrite materials. As can be clearly seen, the losses in Mn—Zn type of ferrites decreases as frequency decreases and are at the range of 350 mW/cm₃ at around 100 kHz for field strengths of about 150 mT which was our level of interest at the lamp starting. As mentioned above, this is a substantially lower value than the losses for the Ni—Zn ferrites (750 mW/cm³) at the same frequency and the same magnetic field.

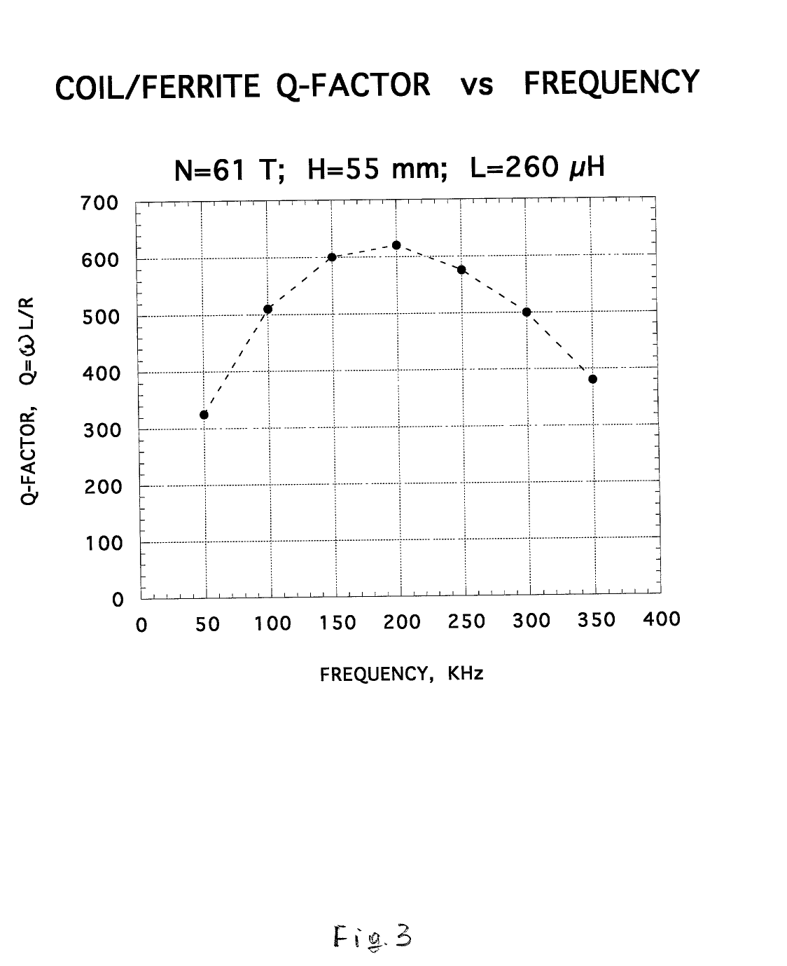

The Q-factor of the coil made from Litz wire and a ferrite core (Mn—Zn material, MN-Zn model) as a function of the driving frequency is shown in FIG. 3. It is seen that within the frequency range of 80 kHz to 300 kHz, the Q-factor is very high (Q>400). The high Q means that the power losses in the coil (ferrite core) are expected to be low at lamp starting and during lamp operation.

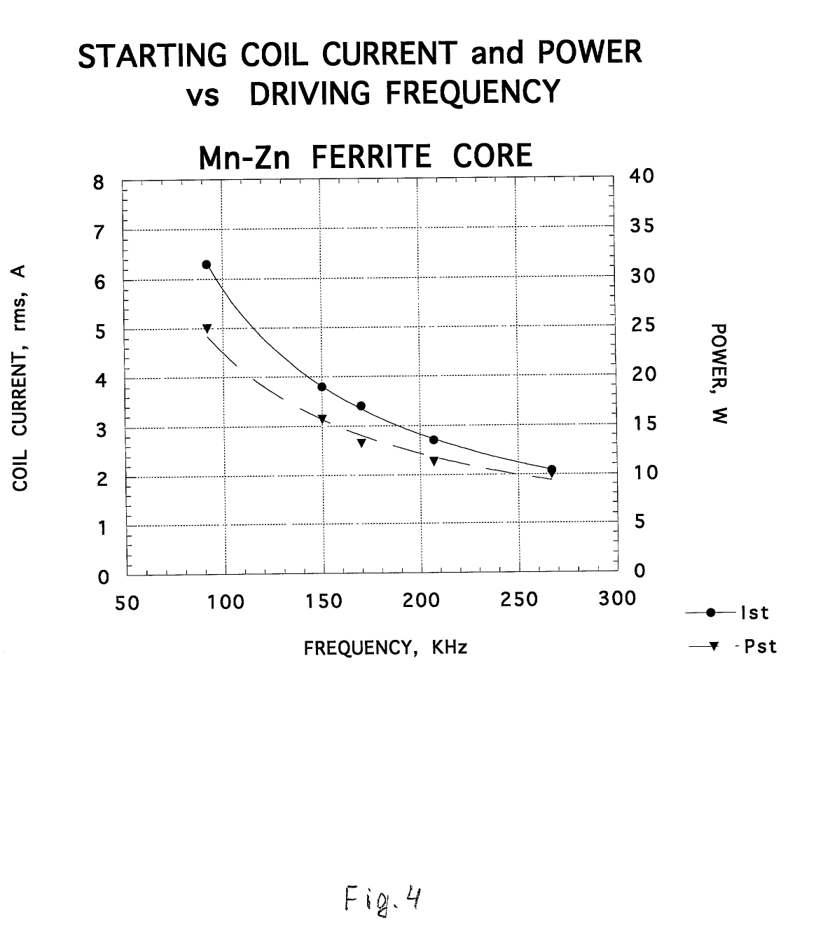

The coil losses at the starting (Pₛₜ) and coil starting current (Iₛₜ) as a function of the driving frequency are given in FIG. 4. It is seen that both Pₛₜ and Iₛₜ decrease as the driving frequency increases, but even at frequencies as low as 100 kHz, Pₛₜ<25 W. The low starting power was achieved due to low power losses in the ferrite core made from Mn—Zn material and Litz wire (again see our patent application Ser. No. 09/083,820).

The change of the coil wire type, number of turns, and ferrite type changes the actual values of coil/ferrite inductance, Lₜₒₜ, coil resistance, R_{coil}, and hence Iₛₜ and Pₛₜ. But in any combination of coil and ferrite, the lowest value of Pₛₜ is achieved at the highest value of coil/ferrite Q-factor.

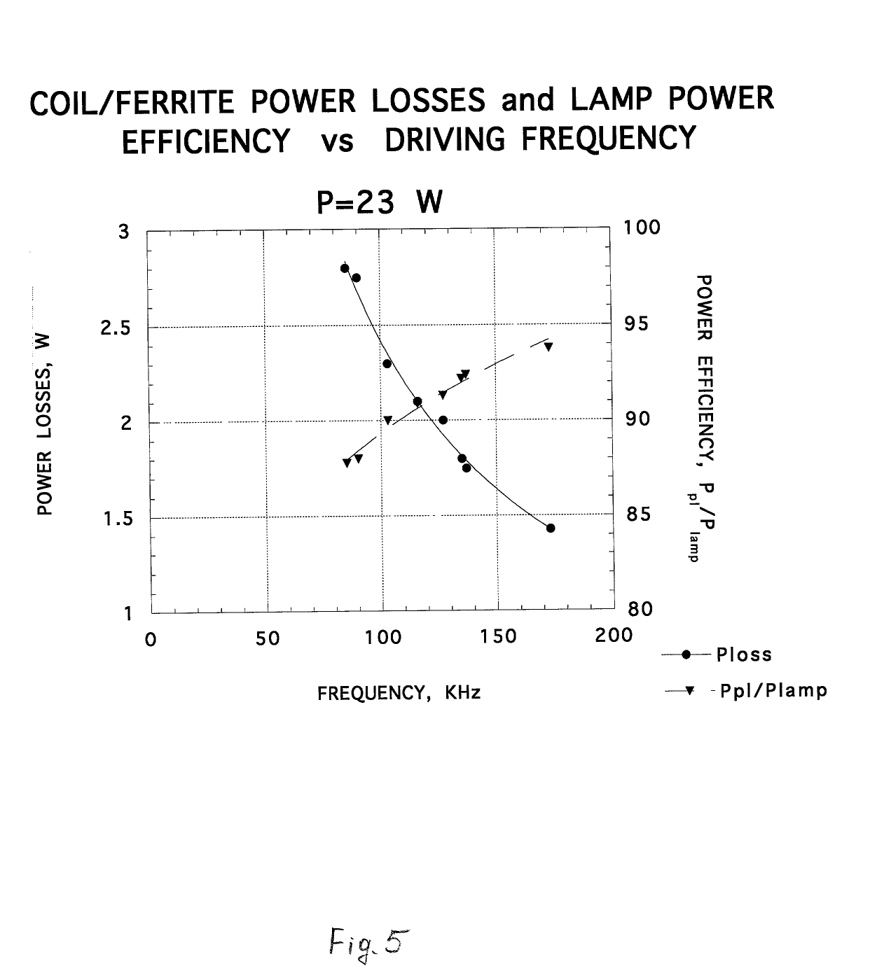

The coil starting voltage, Vₛₜ, depends on the number of turns N. In the case of N=61 turns, Vₛₜ is about 100 OV. The coil power losses during operation, Pₗₒₛₛ, and the lamp power efficiency, Pₚₗ/Pₗₐₘₚ, are shown in FIG. 5 for the lamp operated at 23 W. One can see that coil power losses decrease as frequency grows from 2.7 W at f=85 kHz to 1.5 W at f=170 kHz. The low coil power losses result in high power efficiency that increases from 87% at 85 kHz to 93% at 170 kHz.

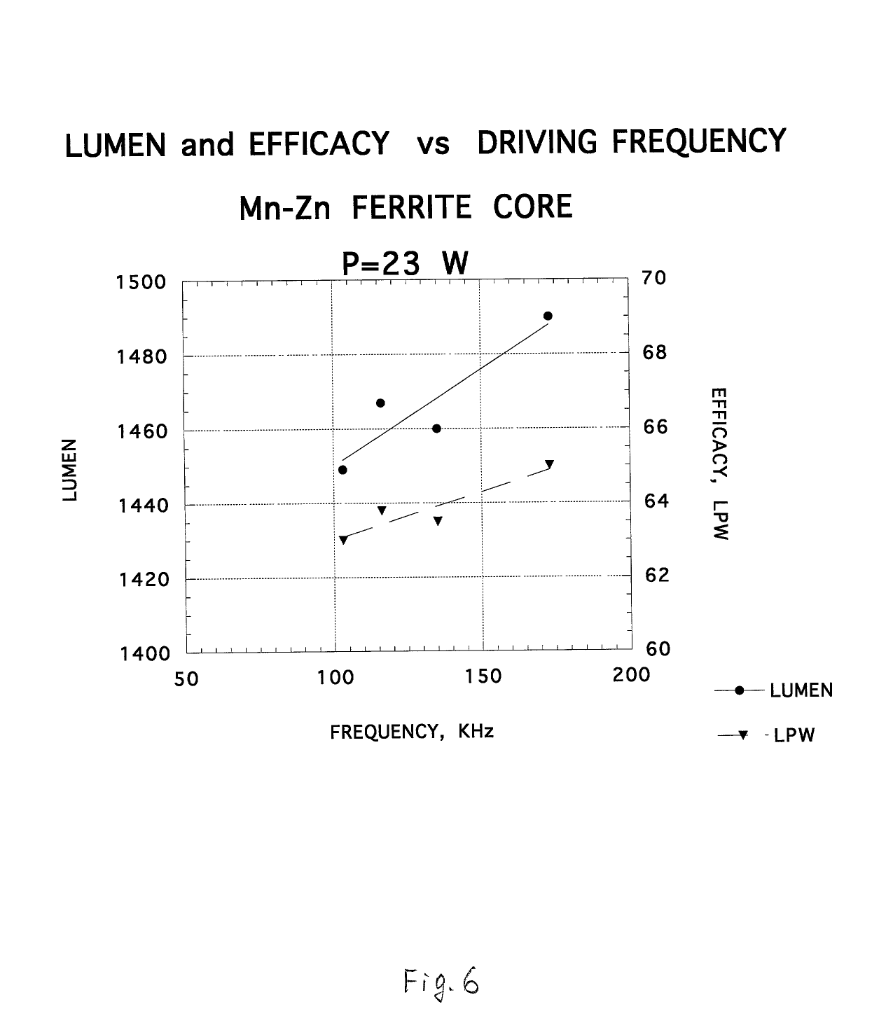

Such a high power efficiency results in high lamp efficacy, lpw. The total lamp output and lamp efficacy measured at P=23 W in the lamp of 60 mm diameter and 65 mm in length are shown as a function of driving frequency in FIG. 6. It is seen that lumen output and lpw decrease as frequency decreases but even at f=100 kHz they are larger than those in electrodeless lamps operated at 2.65 MHz at the same power level such as sold by General Electric (“Genura”).

While it is apparent that change and modifications can be made within the spirit and scope of the present invention, it is our intention, however, only to be limited by the appended claims:

As our invention we claim:

1. An electrodeless flourescent lamp comprising: a glass envelope containing a fill of mercury and an inert gas;
a ferrite core disposed adjacent to said envelope, said core comprising a mixture of iron, manganese and zinc, the weight ratio of the manganese and zinc to the iron being between about 0.2 and 0.7, the weight ratio of the zinc to the manganese being between about 0.2 to 2.0.

2. The electrodeless lamp according to claim 1 wherein said lamp operates at relatively low frequencies of 50-500 kHz, said ferrite core to generating a magnetic field whereby to form a practical lamp which operates with power efficiency not lower than 80%.

3. The electrodeless lamp according to claim 1 wherein said core is of a Mn—Zn ferrite type where the atomic percentage of Mn and Zn can vary over a wide range resulting in very low power losses when current is applied to a coil in close proximity to the core material thereby providing high lamp power efficiency.

4. The electrodeless lamp according to claim 1 wherein said core is in the form of a hollow cylinder and when operated at 100 kHz has less than 100 mW/cm³ losses at 80 mT magnetic field and less than 400 mW/cm³ at high magnetic fields at 150 mT.

5. The electrodeless lamp according to claim 1 wherein said core material enabling the operation of electrodeless fluorescent lamps at 50-500 kHz, with power efficiency and lamp efficacy comparable to those in lamps operated at 2.65 MHz thereby resulting in a lower overall system cost.
